(19) United States
(12) Patent Application Publication
(10) Pub. No.: US 2019/0143264 A1
(43) Pub. Date: May 16, 2019

(54) Device for Water Recovery

(71) Applicant: ecool Advanced Urban Engineering GMBH, Vienna (AT)

(72) Inventors: Emmerich Wilhelm, Vienna (AT); Diana Brehob, Dearborn, MI (US)

(73) Assignee: ecool Advanced Urban Engineering GMBH, Vienna (AT)

(21) Appl. No.: 16/098,863

(22) PCT Filed: May 4, 2016
(86) PCT No.: PCT/AT17/60108

§ 371 Date: Nov. 4, 2018

(30) Foreign Application Priority Data
May 4, 2016 (AT) A 50411/2016

(51) Int. Cl. B01D 53/26; B01D 53/00

(52) U.S. Cl. CPC B01D 53/265; B01D 53/002; B01D 2253/116; B01D 2257/80; B01D 2258/012; B01D 53/268

(57) ABSTRACT

A method and a device for water recovery from exhaust gas is disclosed. The exhaust gas flows into an exhaust gas chamber. Water molecules in the exhaust gas are extracted into a tube system via a molecular sieve. Water molecules in a vapor state are then condensed in a condenser. The exhaust gas flow is controlled by a valve at the end of the exhaust chamber. The method and device allow the greatest possible proportion of water to be recovered from the exhaust gas in a simple way.

### BACKGROUND AND SUMMARY

The disclosure relates to a method for water recovery from exhaust gas which flows through an exhaust gas chamber and into a tube system by a molecular sieve emits water molecules and an apparatus for water recovery from an exhaust gas mass flow with an exhaust chamber having an upstream exhaust port, a downstream exhaust gas outlet and a tube system, wherein the tube system divides the exhaust chamber in an untreated volume and a treated volume, the tube system fluidly connected to a condenser and the untreated volume to the exhaust gas outlet fluidly connected and the volume treated is arranged downstream of the piping system and the device exhibits a valve.

In the combustion of a hydrogen-containing fuel, for example hydrocarbon fuel or hydrogen, there is a significant proportion of water in the exhaust gas mass flow. The table below shows typical components of the exhaust gas in an exhaust gas mass flow of a gasoline engine with spark ignition (Spark ignition, SI) and by a diesel engine with compression ignition (Compression Ignition, CI).

| | | | | Effective molecular | Effective molecular |
|---|---|---|---|---|---|
| | | | Effective molecular | Lennard-Jones-(6, 12) | Lennard-Jones-(6, 12) |
| Combustion Engine | % of total | % of total | Lennard-Jones-(6, 12) | size parameter*) σ | equilibrium distance*) |
| Exhaust Gases | Petrol | Diesel | size parameter*) σ [Å] | [nm] | [symbol] ₘᵢₙ = 2^{1/8} σ [nm] |
| Nitrogen (N2) | 71 | 67 | 3.80 | 0.380 | 0.427 |
| Carbon Dioxide (CO2) | 14 | 12 | 3.94 | 0.394 | 0.442 |
| Water Vapor (H2O) | 12 | 11 | 2.75 | 0.275 | 0.309 |
| Oxygen (02) | 0.06 | 10 | 3.47 | 0.347 | 0.389 |
| Nitrogen Oxide | <0.25 | <0.15 | NO 3.49 | NO 0.349 | 0.392 |
| NOx (NO & NO2) | | | NO₂ 3.83 | NO₂ 0.383 | 0.430 |
| Carbon Monoxide (CO) | 1-2 | <0.045 | 3.69 | 0.369 | 0.414 |
| particulate matter | traces | <0.045 | 100-100000 | 10-10000 | >10 |
| Unbumed hydrocardon | <0.25 | <0.030 | | | |
| Methane (CH4) | | | 3.76 | 0.376 | 0.422 |
| Propane (C3H8) | | | 5.12 | 0.512 | 0.575 |
| n-Octane (C8H1) | | | ~6.50 | ~0.650 | ~0.730 |
| sulfur dioxide (SO2) | traces | <0.030 | ~4.10 | ~0.410 | ~0.460 |

*Often referred to as effective “hard” sphere diameter. [symbol]
indicates data missing or illegible when filed

Typically, the water from the combustion is exhausted into the atmosphere as water vapor. Although, during cold start operation some water condenses and drips from the exhaust pipe.

It is known that there are certain advantages from water injection into combustion systems. For example, it is known that the injection of water into the intake of a spark-ignition engine expands the knock limit, and thus allows a higher compression ratio or less ignition delay, which increases the overall efficiency of the vehicle.

In all combustion systems, the introduction of water reduces the formation of nitrogen oxides (NOx), a known pollutant. Usually, the formation of nitrogen oxides (NOx) is lessened by throttling of the combustion system, by the supply of diluent, and/or post-treatment of exhaust gases in a three-way catalytic converter, a NOx trap, or a NOx catalyst. It is known that reciprocating engines that have been used in aircraft during the Second World War took advantage of water injection for control of knock during take-off. In the same way, vehicles have been retrofitted with water injection to lessen the propensity for engine knock.

Water injection requires a water tank that needs to be refilled with pure water and it must be guaranteed that that the water does not freeze to prevent damage to the system. These requirements have, so far, prevented widespread adoption of this technology. Therefore, the production of pure water for immediate use in the combustion system is desired.

A method for extracting water from the exhaust gas is also desirable for use in areas of the world where water supply is very limited. This could then be applied in transport or in energy production.

As an alternative to carrying a water tank, the extraction of water from the exhaust gas mass flow was proposed.

It is known to condense water from exhaust gas. However, in the existing art, the water is contaminated and acidic, for example by nitric acid, sulfuric acid, and/or carbonic acid. In addition, hydrocarbons of higher molecular weight and/or soot particles can be captured in the water. The resulting water mixture is not usable as drinking water and also insufficient for injection into most combustion systems due to the contaminants, since acids and soot particles can harm the combustion system.

A system for recovering clean water from the exhaust gas is shown in U.S. application Ser. No. 14/156,954, now U.S. Pat. No. 9,174,143. In this disclosure, an exhaust gas of 400-650° C. arrives at a cooling zone. A valve is disposed at the downstream end of the cooling zone. When this valve is opened, or largely opened, the exhaust gas flows through the system essentially unaffected. However, depending on the valve position, on how far the valve is closed, a diversion of the exhaust gas occurs between turns of the tube in the cooling area. This tube is a helical cooling tube, which is supplied by a pipe inlet with a refrigerant and by a discharge pipe the coolant can leave this again.

When the exhaust gas has passed this area with the cooling tube, it comes into an outer peripheral portion in the cooling region. By passing the spaces between the turns of the cooling tube, the exhaust gas is cooled. The exhaust gas mass flow is then further directed to a second peripheral region. This second peripheral region is located in an outer region of a water collecting area.

The exhaust gas, which has passed through the second peripheral region, leaves the system through the same outlet as if the valve had been fully open. The exhaust gas flows between gaps between the turns of a water collecting tube first. The water collecting tube is coated on the outer surface with a molecular sieve.

The size of the pores in the sieve material are provided so that the molecular water diffuses through the screen into the interior of the water collecting tube, while at the same time the other components of the exhaust gas mass flow cannot pass through the molecular sieve.

Through the water collecting tube a fluid or gas is passed, which then also transports the water vapor which has reached the water collecting tube through the molecular sieve, towards at a tube outlet.

A disadvantage of U.S. application Ser. No. 14/156,954 is, however, that some of the water vapor condenses due to cooling of the exhaust gas. This makes downstream collection of water molecules in the water collecting tube impossible because the molecular sieve enables only single molecules of water to pass through. The molecular sieve prevents molecules that are larger than the pores of the sieve to pass through. This is how unwanted chemical substances in the exhaust gas, such as CO2, NOx and the like, are prevented from passing through the molecular sieve. Even two water molecules that bond together cannot pass through the molecular sieve in the water collecting tube. These micro-drops of water are also prevented from passing through the molecular sieve.

Furthermore, these micro-droplets are problematic because they wet the surface of the molecular sieve and thus prevent other water molecules that are not condensed from passing. Thus the micro-drops plug the molecular sieve.

Similar devices are known from DE 19744470 AI, US 2011/0056457 AI, US 2012/0186791 AI, US 2012/0240563 AI, US 2013/0276632 AI and U.S. Pat. No. 9,174,143 BI.

The present disclosure avoids these disadvantages and provides a method and a device that extracts the highest possible proportion of the water from the exhaust gas.

According to this disclosure, exhaust gas first flows past the molecular sieve while water molecules are in their vaporized state and the vapor stream of water molecules is condensed in a condenser which is downstream of the molecular sieve. The flow rate of exhaust gas is controlled by a valve at the end of the exhaust chamber, i.e., the valve is disposed at a location remote from the exhaust port end of the exhaust chamber, i.e., the inlet to the exhaust chamber.

The highest possible amount of water is recovered from the exhaust gas mass flow by letting the exhaust gas flow past the first molecular sieve first and thus keep water molecules in vaporized state and condense the vapor stream of water molecules in a condenser i.e., downstream of the molecular sieve. The formation of micro-drops is prevented upstream of the condenser.

As the flow of the exhaust gas is controlled by the position of a valve and thereby also the contact of the exhaust gas mass flow with the molecular sieve, the result is the simplest way of controlling the process.

The same advantage arises when the valve is controlled by a controller. The controller receives information from sensors such as pressure and temperature in the exhaust chamber.

A simple possibility of adjustment is obtained when the valve is opened by the controller when a temperature in the exhaust chamber is lower than a minimum temperature, or when the valve is opened by the controller when a pressure in the exhaust chamber is higher than a limit pressure.

A pressure difference is maintained across the molecular sieve to serve as a very cheap and simple way to drive the process, i.e., to cause water vapor to enter the molecular sieve in the tube system.

The advantage of a construction as simple as possible is obtained in when the untreated volume is cylindrical and is bounded by the tube system so that the treated volume is annularly disposed about the untreated volume.

In some embodiments, a surface of the tube system is coated with a porous, preferably ceramic material. Pores of the material have a pore diameter which is smaller than a predetermined diameter. The tube system has pores having a tubular pore diameter which is greater than this certain diameter. This gives the advantage that a molecular sieve can be easily provided.

In some embodiments, the valve is continuously adjustable.

To bring the exhaust gas in contact with the tube system, in some embodiments, the tube system has at least one tube which is helically wound. Adjacent turns of the tube are at a distance which is smaller than a predetermined distance.

In one embodiment, it is provided that the tube system has parallel tubes which are connected to a collecting ring. Adjacent tubes are less than a predetermined distance apart. Thereby, the manufacturing effort of the piping system is kept low.

The valve is electrically coupled to a valve control device. A controller is coupled to the valve control device.

In some embodiments, the tube system is fluidly connected with a condenser coupled to a water tank. Thereby, the steam can be condensed to water and stored.

### BRIEF DESCRIPTION OF THE DRAWINGS

FIG. 1 shows a first embodiment of a device for water recovery;

FIG. 2 shows a section view of the first embodiment along line II-II in FIG. 1;

FIG. 3 is a schematic of a combustion system with the device for water recovery;

FIG. 4 is a schematic of a condenser;

FIG. 5 shows a second embodiment of a device for water recovery;

FIG. 6 shows a section view of the second embodiment along line VI-VI in FIG. 5;

FIG. 7 shows a third embodiment of a device for water recovery; and

FIG. 8 shows a section view of the third embodiment along line VIII-VIII in FIG. 7.

### DETAILED DESCRIPTION

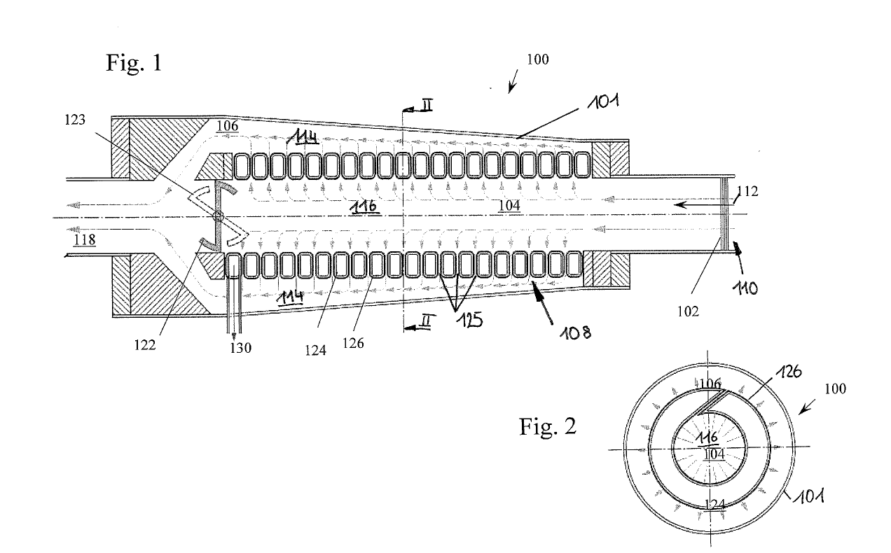

In FIG. 1, an apparatus 100 for water recovery is shown that has an exhaust chamber 101, a particulate filter 102 at an exhaust opening 110 through which exhaust gas 112 flows. The exhaust chamber 101 is divided into an inner portion 104 and an outer portion 106. The exhaust port 110 is arranged upstream of the inner portion 104 and outer portion 106 of the exhaust chamber 101. The inner portion 104 includes the untreated volume 116 and the outer area 106 largely the treated volume 114 of the exhaust gas 112 in exhaust chamber 101.

A particulate filter 102 is not necessary if the combustion process from which the exhaust gas 112 originates produces negligible particulate matter.

Downstream of inner portion 104 and outer portion 106 close to an exhaust outlet 118, a valve 122 is arranged. In FIG. 1 valve 122 is shown in closed position and by reference number 123, the open position of the valve 122 is designated.

In the closed position, most of the exhaust gas 112 from the inner portion 104 of the exhaust chamber 101 flows into the outer region 106 of the exhaust chamber 101. The exhaust gas mass flow 112 passes through gaps 125 between turns of a tube 124, and thus enters into outer region 106.

When the valve 122 is in open position 123, exhaust gas 112 passes without being treated directly by and exists via an exhaust gas outlet 118. When exhaust gas 112 is forced to flow through gaps 125 of the turns of tube 124, the exhaust gas 112 is in contact with the surface of tube 124.

The surface of tube 124 is coated with a material 126 which acts as a molecular sieve. Material 126 has pores with a pore diameter, d, smaller than a certain diameter D. Pores of material 126 are such that only a molecule with a smaller diameter than the predetermined diameter D can pass the molecular sieve. The tube 124 also has openings. These openings have a diameter which is very much larger than the pores of material 126. Material 126 prevents larger molecules from passing through to openings in tube 124.

Water vapor reaching the tube 124 exits the exhaust chamber 101 through a water vapor outlet 130. Water vapor within tube 124 experiences no phase transition.

FIG. 2 shows the flow of the exhaust gas mass flow 112 from inner area 104 in the outer area 106 through gaps between tubes 126. The proportion of the exhaust gas 112 which passes through the gaps is controlled by the position of valve 122.

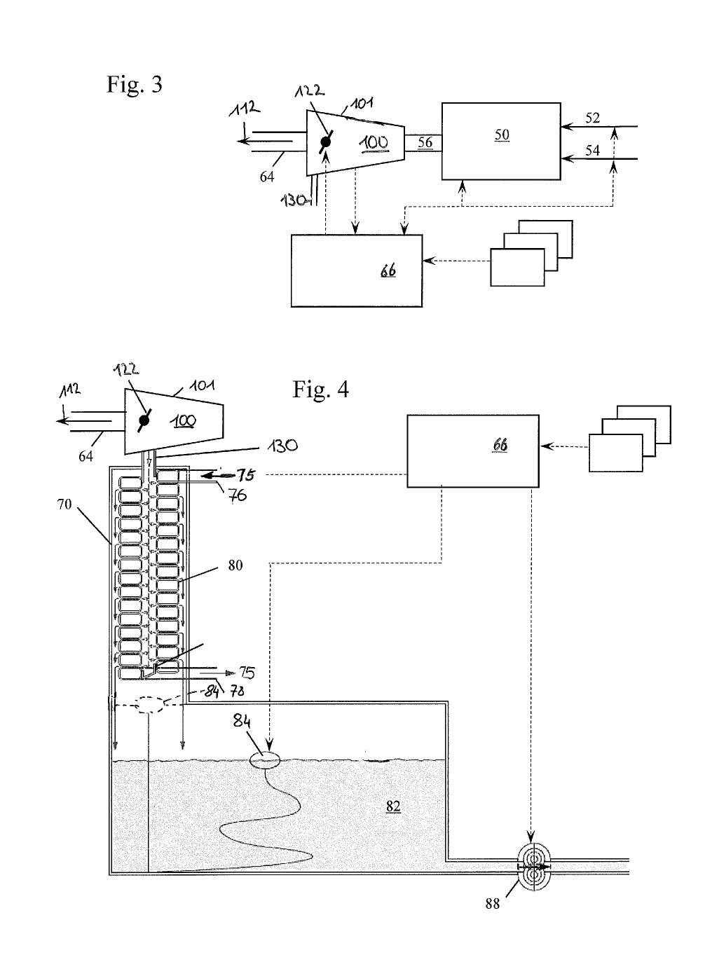

FIG. 3 shows a schema of a combustion system with a device 100 for water recovery. Thereby 4a combustion chamber 50 is supplied with fuel 52 and air 54. The combustion in the combustion chamber 50 can be self-ignited or externally ignited. The exhaust gas 112 leaves combustion chamber 50 through an exhaust pipe 56 into the apparatus 100 for water recovery in which the valve 122 is arranged. The steam escapes through the water outlet 130 of the exhaust chamber 101 and the exhaust gas mass flow 112 leaves exhaust chamber 101 through an exhaust pipe 64.

A control unit (ECU) 66 is electronically connected to valve 122 and combustion chamber 50 and regulates the supply of fuel 52 and air 54 to the combustion chamber 50. Thereby the signals of apparatus 100, combustion chamber 50, and from other sensors 72 are used as decision support. Such signals can include the exhaust gas temperature, ambient temperature, pressure, humidity, the valve position, the fuel inflow, the air supply may include etc. Electrical connections are shown by dashed lines.

In FIG. 4, a low-pressure system is shown that includes a condenser 70 for the steam. Condenser 70 has a spiral-shaped conduit 80. A coolant 75 flows through conduit 80. Conduit 80 has a coolant inlet 76 and a coolant outlet 78. Water vapor is condensed by cooling with coolant 75 in condenser 70. Condensed, liquid water collects in a water reservoir 82. Water reservoir 82 has a float 84 and a pump 88 arranged downstream to transport the water out of water reservoir 82 onward. In some embodiments, pump 88 is electronically coupled to and controlled by ECU 66.

When float 84 indicates that water reservoir 82 is full, ECU 66 either opens valve 122 or stops the cooling of water vapor in condenser 70.

A lower pressure is maintained in tube system 124 than in exhaust chamber 101. This ensures that that water vapor is drawn through the molecular sieve into condenser 70. The lower pressure level is a result of the cooling and condensation process and drives the process.

If the cooling is stopped, then pressure in the condenser 70 rises within a short time. Further the condensation process is stopped. Thus, the entire process can be controlled by the cooling system.

To speed up control of the process, pressure valves, not shown, can be provided in condenser 70, via which the pressure level can be controlled more quickly and irrespective of the condensation.

Pump 88 serves to transport the water from water reservoir 82 to its next destination that is not a part of this disclosure.

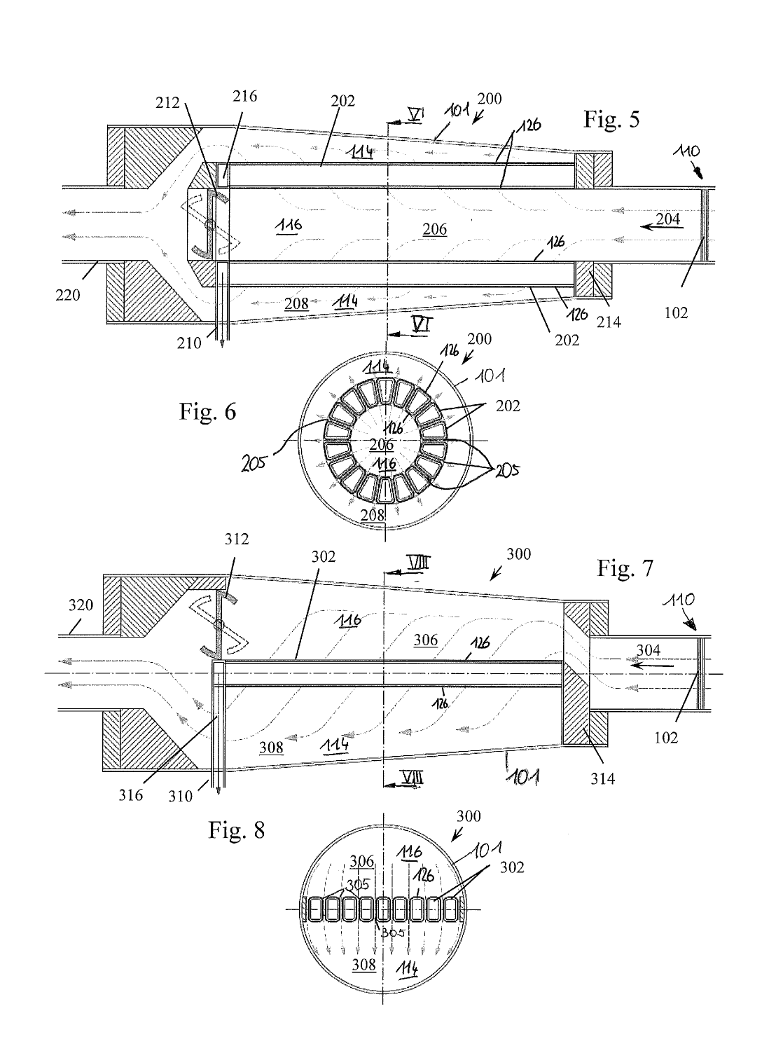

In an alternative, second embodiment of a device 200 in FIG. 5 is a plurality of parallel tubes 202 are arranged in a circle between an inner portion 206 and an outer portion 208. Tubes 202 are fixed to the upstream end of the second embodiment of the device 200 by a guide ring 214. These parallel tubes 202 are fluidly connected via a collecting ring 216 which is on the other hand fluidly connected to a water outlet 210.

Inner portion 206 of apparatus 200 holds an untreated volume 116 of an exhaust gas 204 and the outer area. A treated volume 114 is separated from untreated volume 116 by parallel tubes 202. Treatment here means the separation of the molecular water from exhaust as 204 by the molecular sieve.

Exhaust gas 204 is directed into the inner portion 206. If a downstream valve 212 is closed, then exhaust gas 204 flows through gaps 205 (referring to FIG. 6 which is a cross section of FIG. 5) between tubes 202 to reach outer portion 208. Tubes 202 are coated with a porous ceramic material 126, which forms a molecular sieve. The pores have a pore diameter, d, which is smaller than the predetermined diameter D, so that the molecules with a size smaller than the effective diameter of water can pass through the sieve and all the larger molecules are prevented from entering tubes 202. Water vapor collected in tubes 202 passes through the collection ring 216 to a water outlet 220. Exhaust gas 204 which flows through inner portion 206 and outer portion 208 exits through an exhaust gas outlet 220.

In FIG. 6, the cross section of the second embodiment of the device 200 is shown. Parallel tubes 202 comprise a trapezoidal profile, whereby between two adjacent tubes 202 there is a gap 205 with a distance A between tubes 202 in the circumferential direction. Distance A is smaller than a certain distance B, which is the largest distance at which the molecular sieve is most useful to extract water without too large a pressure drop.

A third embodiment is shown in FIGS. 7 and 8. An apparatus 300 is fed an exhaust gas 304 that passes through the particulate filter 102 into a first portion 306 of the device, which is separated from a second area 308 by a tube wall 302.

Substantially the first portion 306 comprises the untreated volume 116 of exhaust gas 304 and second portion 308 comprises substantially the treated volume 114 of the exhaust gas mass flow 304.

Tube wall 302 is substantially centered in exhaust chamber 101. When a valve 312 is closed, exhaust gas 304 flows from the first portion 306 through gaps 305 (visible in FIG. 8 which is a cross section of FIG. 7) between tubes of the tube wall 302 into second portion 308. Tubes of tube wall 302 are coated with a porous material 126, which forms a molecular sieve. Exhaust gas 304 exits through an exhaust outlet 320. The tubes of the tube wall 302 are transversely disposed at a diameter of device 300.

The tubes 124 in the first embodiment of the device 100, the parallel tubes 202 of the second embodiment of the device 200 and the tube wall 302 of the third embodiment of the device 300 are subsumed under the term tube system.

The devices 200, 300 in the second and third embodiments have an exhaust gas chamber 101 in analogy to the first embodiment.

In the table above, the exhaust components are given in typical spark-ignited and compression-ignition engines. The three columns on the right show the molecular diameters of the components of exhaust gas. Since particulate matter is an agglomeration of carbon particles, particulate matter varies greatly in size based on the degree of agglomeration. Nevertheless, these particles are not molecular and, as such, are much larger in diameter than any of the molecular components. If the fuel does not completely oxidize, this will also result in a proportion of unburned hydrocarbons in the exhaust gas. Much of the unburned hydrocarbons is methane, CH4. From the above table, methane has an effective “hard” molecular diameter (Lennard-Jones (6,12) distance parameter) of 3.76 Å, and that the somewhat more complicated larger propane (C3H8) has an effective “hard” molecular diameter (Lennard-Jones (6,12) distance parameter) of 5.12 Å. All exhaust constituents, with the exception of water molecules, have an effective “hard” molecular diameter of greater than 3.00 Å. The porous material 126 having pores or passageways with a largest diameter along its length of less than about 3.00*2^{1/6} Å (i.e., less than about 3.50 Å) is therefore suitable as a molecular sieve. As a result, only water molecules can be transferred through material 126 coated on tubes 124, 202, and/or 302.

1. A method for recovering water from an exhaust gas (112; 204; 304), comprising:
passing the exhaust gas through an exhaust chamber (101); and
extracting molecules of water through a molecular sieve into a tube system (124; 202; 302), wherein:
the exhaust gas (112; 204; 304) first flows past the molecular sieve;
water molecules in a vapor state are extracted;
water molecules in the vapor state are condensed in a condenser (70); and
flow of the exhaust gas (112; 204; 304) is controlled by a valve (122; 212; 312) at the downstream end of the exhaust gas chamber (101).

2. The method according to claim 1, wherein flow of exhaust gas (112; 204; 304) is controlled by the position of the valve (122; 212; 312) and thus also the contact of the exhaust gas (112; 204; 304) has with the molecular sieve.

3. The method according to claim 2, wherein the valve (122; 212; 312) is controlled by a controller; and the controller receives information from sensors including at least one of pressure and temperature in the exhaust chamber.

4. The method according to claim 3, wherein the valve (122; 212; 312) is opened by the controller when a temperature of the exhaust chamber is lower than a predetermined temperature.

5. The method according to claim 4, wherein the valve (122; 212; 312) is opened by the controller when a pressure in the exhaust chamber is greater than a predetermined pressure.

6. The method of claim 1, wherein the water molecules from the exhaust gas (112; 204; 304) are driven through the molecular sieve into the tube system (124; 202; 302) by a pressure difference.

7. An apparatus (100; 200; 300) for recovering water from an exhaust gas (112; 204; 304), comprising:
an exhaust chamber (101) having an exhaust port arranged upstream (110);
an exhaust gas outlet arranged downstream (118; 220; 320); and
a tube system (124; 202; 302), wherein:
the tube system (124; 202; 302) separates the exhaust chamber (101) into an untreated portion (116) and a treated portion (114);
the tube system (124, 202; 302) is fluidly coupled to a condenser (70); and
the untreated portion (116) is fluidly coupled to the exhaust port (110);
the treated portion (114) is arranged downstream of the tube system (124; 202; 302);
a valve (122; 212; 312) is arranged in the exhaust chamber (101) remote from the exhaust port (110).

8. The apparatus (100; 200) according to claim 7, wherein the untreated portion (116) is cylindrical and is bounded by the tube system (124; 202) such that the treated portion (114) is arranged annularly around the untreated portion (116).

9. The apparatus (100; 200; 300) according to claim 7, wherein a surface of the pipe system (124; 202; 302) is coated with a porous material (126) having a pore diameter d which is smaller than a predetermined diameter D; and
the pipe system (124, 202, 302) has pores having a pipe pore diameter e, which is larger than the predetermined diameter, D.

10. The apparatus (100; 200; 300) according to claim 7, wherein the valve (122; 212; 312) is continuously adjustable.

11. The apparatus (100) according to claim 7, wherein:
the tube system (124) comprises at least one pipe (124) which is helically wound; and
adjacent windings of the tube have a gap which is smaller than a predetermined distance.

12. The apparatus (200) according to claim 7, wherein:
the pipe system (202) has parallel tubes (202) which are fluidly coupled to a collecting ring (216); and
adjacent tubes (202) have a gap therebetween which is smaller than a predetermined distance.

13. The apparatus (100; 200; 300) according to claim 7, wherein the valve (122; 212; 312) is electronically coupled to a control unit (66).

14. The apparatus (100; 200; 300) according to claim 13, further comprising: at least one of a temperature sensor and a pressure sensor disposed in the exhaust chamber (101), wherein the control unit (66) is electronically coupled to the at least one sensors for receiving signals of at least one of pressure and temperature in the exhaust chamber (101).

15. The apparatus (100; 200; 300) according to one claim 7 of claims 7 to 14, wherein:
the tube system (302 124; 202) is fluidly coupled to a condenser (70); and
the condenser (70) is fluidly coupled to a water reservoir (82).
